(19) United States
(12) Patent Application Publication
(10) Pub. No.: US 2017/0371126 A1
(43) Pub. Date: Dec. 28, 2017

(54) OPTICAL PROJECTION DEVICE AND PROJECTOR

(71) Applicant: SEIKO EPSON CORPORATION, Tokyo (JP)

(72) Inventor: Naoto TAKEHANA, Matsumoto-shi (JP)

(73) Assignee: SEIKO EPSON CORPORATION, Tokyo (JP)

(21) Appl. No.: 15/542,573

(22) PCT Filed: Jan. 7, 2016
(86) PCT No.: PCT/JP2016/000054

§ 371 Date: Jul. 10, 2017

(30) Foreign Application Priority Data
Jan. 27, 2015 (JP) 2015-013027

(51) Int. Cl. G02B 7/02; G03B 21/14; G02B 13/16; G02B 13/24; G02B 27/00; G03B 21/28; G02B 5/00

(52) U.S. Cl. CPC G02B 7/023; G02B 13/24; G02B 7/021; G03B 21/142; G02B 27/0025; G02B 13/16; G02B 5/005; G03B 21/28

(57) ABSTRACT

An optical projection device, which effectively suppresses variation in aberration due to irregularities in installation positions of lens groups which form an optical projection system, and a projector which includes the optical projection device are provided. In a lens group, which includes a diaphragm, in an optical projection device which includes a plurality of lens groups, a lens frame is divided between the diaphragm and a lens which is adjacent to the diaphragm, one lens frame which is acquired through the division includes an adjustment portion, which maintains a position of an optical axis to be adjusted, with respect to the other lens frame which is acquired through the division.

### TECHNICAL FIELD

The present invention relates to an optical projection device and a projector which includes the optical projection device.

### BACKGROUND ART

In the related art, a projector is known that modulates light (emission light), which is emitted from a light source, in an optical modulator according to image information, and enlarges and projects the modulated light by an optical projection device. In addition, there is a projector which performs projection on a projection surface of a screen or the like from a short distance at a wide angle of view. In the projector, a short focus optical projection device is used as an optical projection device which is capable of performing projection from the short distance at the wide angle of view. Meanwhile, in recent years, a refracting optical system and a refracting and reflecting compound optical system are used as the optical projection system which performs projection from the short distance at the wide angle of view.

PTL 1 discloses an optical projection image forming system which is configured to effectively prevent vignetting of an image forming light flux due to a lens barrel while reducing inclination with respect to an optical axis of oblique light flux in oblique projection performed in an optical system using a fixed lens portion, a moving lens portion, and a concave mirror.

### CITATION LIST

### Patent Literature

PTL 1: JP-A-2011-85922

### SUMMARY OF INVENTION

### Technical Problem

In an optical projection system in a case where projection (short distance projection) is performed from a short distance at a wide image angle, a distance from an optical projection device to a screen is extremely close, and thus variation in aberration due to focus is large compared to a general optical projection device. In addition, the optical projection system is configured to use a plurality of spherical lenses and non-spherical lenses which are highly sensitive, and thus irregularities in installation positions of the respective lenses significantly have a considerable influence on the variation in aberration, compared to the general optical projection device. Therefore, deterioration in contrast or the like is easily generated on an image, which is projected on a screen, due to the curvature of field and the variation in aberration, and thus there is a problem in that image quality is considerably deteriorated. Therefore, in a case where lens groups are assembled, it is necessary to suppress the irregularities in installation positions of the respective lenses as far as possible, to perform optical adjustment after the assembling, and the like.

Therefore, it is desired to provide an optical projection device, which effectively suppresses a variation in aberration due to the irregularities in installation positions of lens groups which form the optical projection system, and a projector which includes the optical projection device.

### Solution to Problem

The present invention is made to solve at least a part of the above-described problems, and can be realized as forms and application examples below.

### Application Example 1

An optical projection device according to the present application example includes: a plurality of lens groups; and a plurality of lens frames that accommodate the lens groups, in which the optical projection device projects incident image light, in which a lens group, which has a diaphragm, in the plurality of lens groups, has a lens frame which is divided between the diaphragm and a lens which is adjacent to the diaphragm, and in which one lens frame, which is acquired through the division, includes an adjustment portion, which maintains a position of an optical axis to be adjusted, with respect to the other lens frame which is acquired through the division.

According to the optical projection device, in the lens group which has the diaphragm, the lens frame is divided between the diaphragm and the lens which is adjacent to the diaphragm. Meanwhile, the diaphragm (opening diaphragm) is a place where light flux, which is incident from an image side, is most spread, and, in addition, highly-sensitive lenses are provided in front and rear of the diaphragm. Therefore, in a case where the lens frame is divided between the diaphragm and the lens which is adjacent to the diaphragm, the front and rear lenses of the diaphragm are separated. In a case where a position of the optical axis is adjusted using the adjustment portion (hereinafter, referred to as optical axis adjustment), the diaphragm becomes a most efficient place for controlling the light flux. As described above, in a case where the optical axis adjustment is performed by dividing the lens frame between the diaphragm and the lens which is adjacent to the diaphragm, high definition adjustment is performed, and thus it is possible to correct the aberration due to irregularities and deviation. In addition, it is possible to prevent lens sensitivity from being deteriorated. In a case where it is possible to prevent defects, such as deterioration in contrast and blur, it is possible to improve qualities of a projected image.

Accordingly, it is possible to realize the optical projection device which effectively suppresses variation in aberration due to irregularities in installation positions of the lenses.

### Application Example 2

An optical projection device according to the present application example includes: a plurality of lens groups; and a plurality of lens frames that accommodate the lens groups, in which the optical projection device projects incident image light, in which a lens group, which is fixed, in the plurality of lens groups, has a lens frame which is divided at a specified position, and in which one lens frame, which is acquired through the division, includes an adjustment portion, which maintains a position of an optical axis to be adjusted, with respect to the other lens frame which is acquired through the division.

According to the optical projection device, in a case where a lens frame of the fixed lens group is divided at the specified position and the optical axis adjustment is performed using the adjustment portion, it is possible to adjust the highly-sensitive lens with high definition, it is possible to prevent the deterioration in the lens sensitivity due to the irregularities in the installation positions of lenses, and it is possible to effectively suppress variation in aberrations. Furthermore, in a case where the fixed lens group, which is not influenced by eccentricity and inclination of the lens due to movement, is adjusted, it is possible to perform higher definition adjustment.

### Application Example 3

An optical projection device according to the present application example includes: a plurality of lens groups; and a plurality of lens frames that accommodate the lens groups, in which the optical projection device projects incident image light, in which a lens group, which is disposed in a most incident side of the light, in the plurality of lens groups, has a lens frame which is divided at a specified position, and in which one lens frame, which is acquired through the division, includes an adjustment portion, which maintains a position of an optical axis to be adjusted, with respect to the other lens frame which is acquired through the division.

According to the optical projection device, in a case where the lens frame of the lens group, which is disposed on the most incident side of the incident image light, is divided at the specified position and the optical axis adjustment is performed using the adjustment portion, it is possible to prevent the deterioration in the lens sensitivity due to the irregularities in the installation positions of lenses and it is possible to effectively suppress the variation in aberrations. Furthermore, since the lens group, on the most incident side in which spread of the light flux is small and which has high sensitivity of the installation position of each lens in the optical projection device, is generally adjusted, it is possible to perform higher definition adjustment.

### Application Example 4

In the optical projection device according to the application examples, it is preferable that the adjustment portion includes a plurality of adjusting hole portions and/or adjusting notch portions on an outer circumferential surface of the one lens frame in a radial direction around the optical axis, and the other lens frame is installed on an inner circumferential side of the one lens frame with a gap in the radial direction, and has an exposed outer circumferential surface which faces the adjusting hole portions and/or the adjusting notch portions.

According to the optical projection device, for example, adjusting jigs are inserted into the plurality of adjusting hole portions and/or the adjusting notch portions which exist on the outer circumferential surface of the one lens frame, and are in contact with an exposed outer circumferential surface of the other lens frame. Furthermore, in a case where the jigs are moved, the other lens frame is moved with respect to the one lens frame. Therefore, it is possible to perform adjustment which causes the optical axis of the one lens frame to coincide with the optical axis of the other lens frame. Accordingly, it is possible to effectively suppress the variation in aberrations due to the irregularities in the installation positions of the lenses.

### Application Example 5

In the optical projection device according to the application example, it is preferable that the plurality of adjusting hole portions and/or the adjusting notch portions are formed in positions facing each other across the optical axis.

According to the optical projection device, the adjusting hole portions and/or the adjusting notch portions are formed in the positions facing each other across the optical axis. Therefore, in a case where the optical axis adjustment is performed, it is possible to maintain the other lens frame in a balanced manner using the jigs, and it is possible to stably move (adjust) the other lens frame.

### Application Example 6

It is preferable that the optical projection device according to the application example further includes a fixing portion that fixes the other lens frame to the one lens frame, in which the fixing portion includes the plurality of fixing hole portions and/or the fixing notch portions, which expose the outer circumferential surface of the other lens frame, on the outer circumferential surface of the one lens frame in the radial direction around the optical axis.

According to the optical projection device, after the optical axis adjustment is performed on the lens frames acquired through the division, it is possible to fix the other lens frame to the one lens frame by injecting an adhesive or the like into the exposed outer circumferential surface of the other lens frame from the plurality of fixing hole portions and/or the fixing notch portions which are included in the fixing portion.

### Application Example 7

In the optical projection device according to the application example, it is preferable that the plurality of the fixing hole portions and/or the fixing notch portions are formed at approximately regular intervals.

According to the optical projection device, the plurality of fixing hole portions and/or the fixing notch portions are formed approximately at regular intervals, and thus it is possible to perform balanced efficient fixing. Therefore, it is possible to improve qualities with respect to fall and vibration.

### Application Example 8

In the optical projection device according to the application example, it is preferable that the other lens frame includes groove portions which face the fixing hole portions and/or the fixing notch portions.

According to the optical projection device, in a case where an adhesive or the like is injected from the fixing hole portions and/or the fixing notch portions, the adhesive is accumulated in the groove portions included in the other lens frame, and thus it is possible to improve adhesive strength in such a way that an adhesive area is enlarged, and the adhesive, which is cured in the groove portions, performs a function as a wedge, or the like.

### Application Example 9

It is preferable that the optical projection device according to the application example further includes a reflecting mirror that reflects light emitted from the lens group.

According to the optical projection device, even in a case where the reflecting optical system, which includes the reflecting mirror, is added to the refracting optical system, it is possible to acquire the above-described effects.

### Application Example 10

In the optical projection device according to the application example, it is preferable that the plurality of lens groups are formed to adjust focus.

According to the optical projection device, in a case where short distance projection is performed, it is possible to suppress variation in aberration due to the focus adjustment to be small.

### Application Example 11

A projector according to the present application example includes: one of the optical projection devices described above; a light source device that emits light; and an optical modulator that adjusts the light according to image information.

According to the projector, the optical projection device which effectively suppresses variation in aberration is included, and thus it is possible to improve quality of a projection image.

### BRIEF DESCRIPTION OF DRAWINGS

FIG. 1 is a perspective diagram illustrating a use form of a projector according to an embodiment.

FIG. 2 is a diagram schematically illustrating an optical unit of a projector.

FIG. 3 is a perspective diagram illustrating an optical projection device.

FIG. 4 is a schematic sectional diagram illustrating the optical projection device.

FIG. 5 is an exploded perspective diagram illustrating the optical projection device.

FIG. 6 is an exploded perspective diagram illustrating the optical projection device.

FIG. 7 is a perspective diagram illustrating a fourth lens group and a fourth lens frame.

FIG. 8 is a sectional diagram illustrating the fourth lens group and the fourth lens frame viewed from an optical axis direction.

FIG. 9 is a sectional diagram illustrating the fourth lens group and the fourth lens frame viewed from a direction which is orthogonal to the optical axis direction.

### DESCRIPTION OF EMBODIMENT

Hereinafter, an embodiment will be described with reference to the accompanying drawings.

### Embodiment

### [Use Form and Operation of Projector 1]

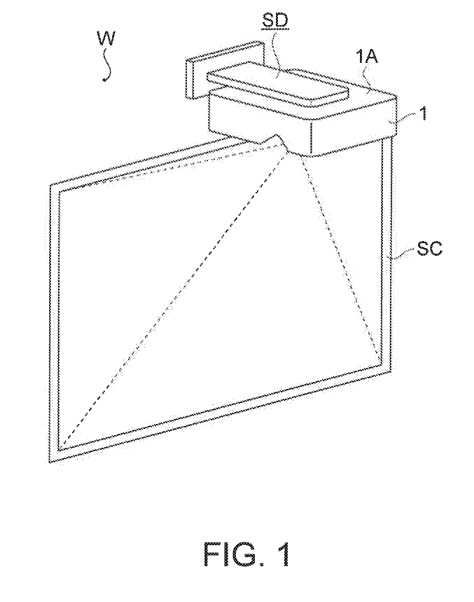

FIG. 1 is a perspective diagram illustrating a use form of a projector 1 according to the embodiment. Meanwhile, the projector 1 includes an optical projection device 5 according to the embodiment.

As illustrated in FIG. 1, the projector 1 according to the embodiment is installed to be supported by a support device SD that is installed on a wall surface W such that a bottom surface 1A becomes an upper side. In addition, the screen SC as a projection surface is installed in a position which is a lower side of the wall surface W, on which the projector 1 is installed, and is close to the projector 1.

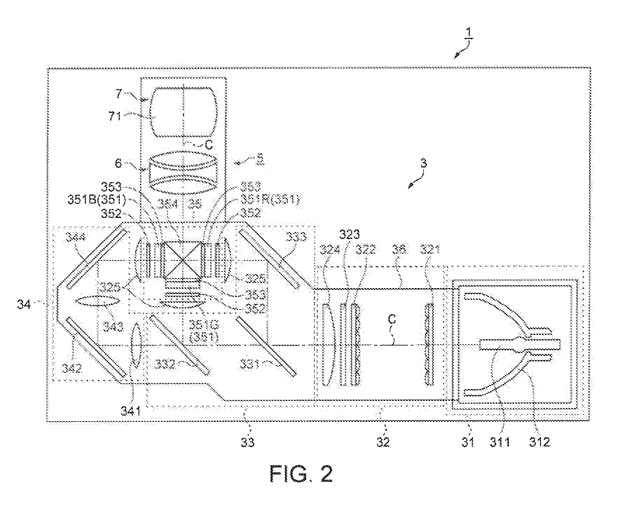

The projector 1 is a device that modulates emission light, which is emitted from a light source device 31, in liquid crystal panels 351 as optical modulators according to image information, and enlarges and projects the modulated light as image light through the optical projection device 5 (see FIG. 2 for all elements). Meanwhile, the projector 1 projects the image light (projection light), which is reflected in a reflecting mirror 71 of the optical projection device 5 (see from FIG. 2), to the screen SC from an opposite side of the bottom surface 1A. The projector 1 according to the embodiment is formed as a so-called short focus-type projector which performs projection on a large screen (wide angle of view) with respect to the screen SC from a short distance.

### [Configuration and Operation of Optical Unit 3 of Projector 1]

FIG. 2 is a diagram schematically illustrating an optical unit 3 of the projector 1. The optical unit 3 operates under the control of a control portion (not shown in the drawing), and forms the image light according to the image information. As illustrated in FIG. 2, the optical unit 3 includes a light source device 31 which includes a light source lamp 311 and a reflector 312, and an illumination optical device 32 which includes lens arrays 321 and 322, a polarization conversion element 323, a superimposition lens 324, and a collimating lens 325. In addition, the optical unit 3 includes a color separation optical device 33, which includes dichroic mirrors 331 and 332 and a reflecting mirror 333, and a relay optical device 34 which includes an incident-side lens 341, a relay lens 343, and reflecting mirrors 342 and 344.

In addition, the optical unit 3 includes an electro-optic device 35 which includes three liquid crystal panels 351 (it is assumed that a red light (R light) liquid crystal panel is 351R, a green light (G light) liquid crystal panel is 351G, and a blue light (B light) liquid crystal panel is 351B) as optical modulators, three incident-side polarizing plates 352, three emission-side polarizing plates 353, and a cross dichroic prism 354 as a color composite optical device. In addition, the optical unit 3 includes the optical projection device 5, and an optical component housing 36 which accommodates the respective optical devices 31 to 35.

With the above-described configuration, the optical unit 3 separates light, which is emitted from the light source device 31 and passes through the illumination optical device 32, into three color light, that is, R light, G light, and B light in the color separation optical device 33. In addition, each separated color light is modulated in each of the liquid crystal panels 351 according to the image information, and is formed as modulated light for each color light. The modulated light for each color light is incident into the cross dichroic prism 354, is composed as the image light, and is enlarged and projected on the screen SC (FIG. 1) or the like through the optical projection device 5. Meanwhile, since the above-described respective optical devices 31 to 35 are used as an optical system of various general projectors, the detailed description thereof is omitted.

### [Outline of Optical Projection Device 5]

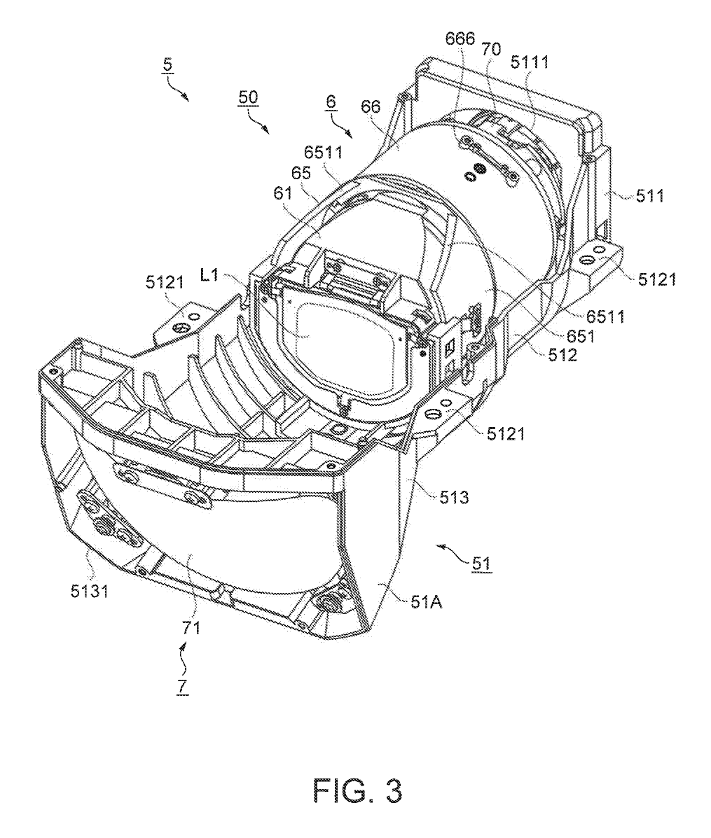

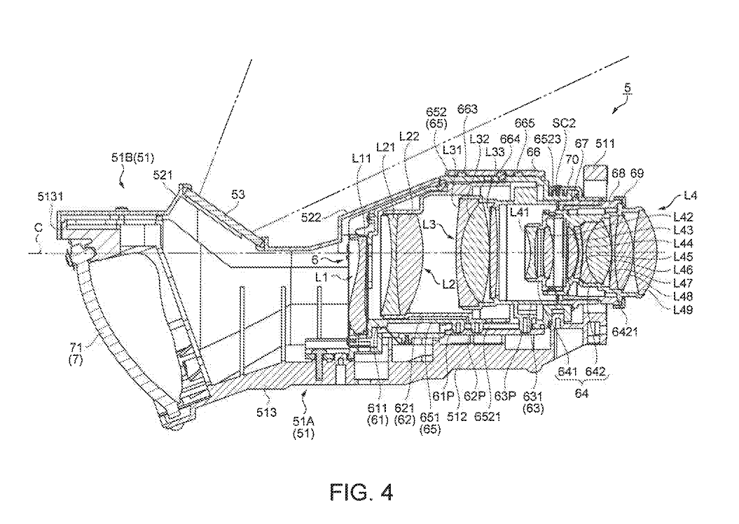

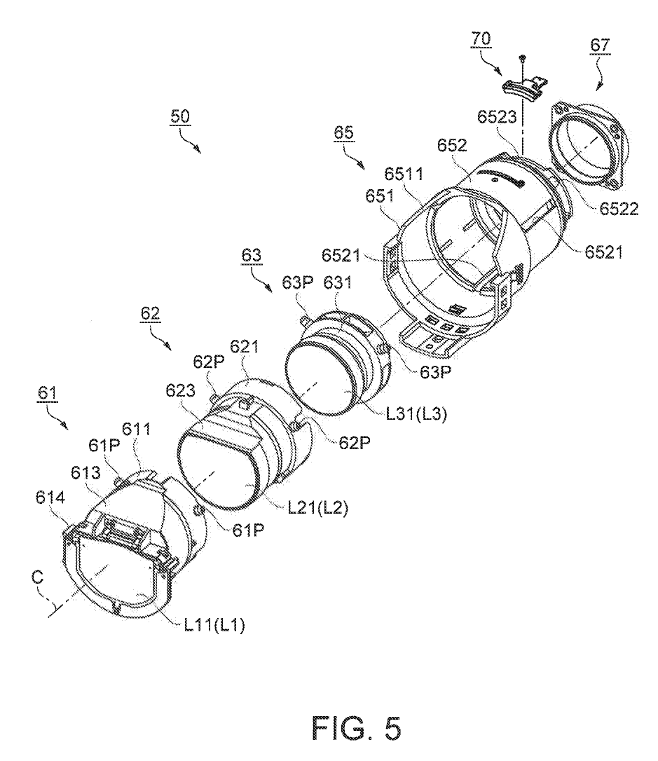

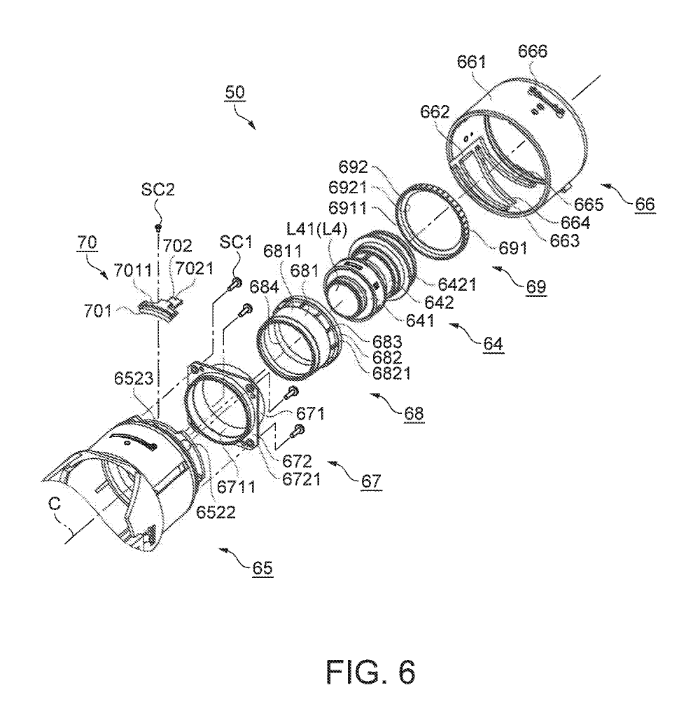

FIG. 3 is a perspective diagram illustrating the optical projection device 5. FIG. 4 is a schematic sectional diagram illustrating the optical projection device 5. FIGS. 5 and 6 are exploded perspective diagrams illustrating the optical projection device 5. Meanwhile, FIG. 5 mainly illustrates a first lens frame 61 to a guide barrel 65. FIG. 6 mainly illustrates a first adjusting barrel 67 to a cam barrel 66 subsequent to the guide barrel 65. Meanwhile, one of overlapping members in FIGS. 5 and 6 is illustrated by being simplified. In addition, a second optical system 7, an optical projection housing 51 (a housing main body 51A and a cover 51B), and a light transmission plate 53 are not illustrated in FIGS. 5 and 6. Meanwhile, a unit, which is assembled without the members, is called an optical projection unit 50 and is appropriately used hereinafter. The optical projection device 5, which includes configurations and operations of the respective members included in the optical projection device 5, will be described with reference to FIGS. 3 to 6.

Subsequent to FIG. 3, for convenience of explanation, an incident side, to which the image light is incident, is referred to as a rear side and an emission side, in which the image light is emitted from a first optical system 6, is referred to as a front side, in the first optical system 6 of the optical projection device 5. In addition, in a drawing of FIG. 3, it is assumed that an upper direction on the paper is an upper side and a down direction is a lower side. In addition, left and right directions acquired in a case where the emission side, in which the image light is emitted, is viewed from the first optical system 6 are appropriately used as a left side and a right side. Accordingly, in FIG. 1, the optical projection device 5 is installed in a state in which up and down and left and right directions are reversed. As a result, the projector 1 is in a state in which up and down and left and right are reversed.

As illustrated in FIGS. 3 and 4, the optical projection device 5 includes, as an optical projection system, an optical system in which the first optical system 6 (refracting optical system) is combined with the second optical system 7 (reflecting optical system). The optical projection device 5 according to the embodiment refracts the image light, which is emitted from the cross dichroic prism 354, in the first optical system 6, reflects the image light in the second optical system 7 which includes the reflecting mirror 71, and projects the image light on the screen SC. The optical projection device 5 includes, as the first optical system 6, a plurality of lens groups in which one or more lenses are set for one lens group, and the lens groups are arranged along an optical axis C. Meanwhile, the optical projection device 5 according to the embodiment is formed as a short focus optical projection device, and the first optical system 6 has a function of performing focus adjustment on incident image light.

The optical projection device 5 schematically includes the optical projection housing 51 which is a base of the device, the first optical system 6 and the second optical system 7 which are accommodated in the optical projection housing 51, and the light transmission plate 53 through which reflection light (projection light) reflected in the reflecting mirror 71 passes. In addition, the optical projection housing 51 includes the housing main body 51A which accommodates the first optical system 6 and the second optical system 7, and the cover 51B which covers an upper portion of the housing main body 51A and maintains the light transmission plate 53.

The first optical system 6 includes the guide barrel 65, the cam barrel 66, first to fourth lens groups L1 to L4 which are sequentially arranged along the optical axis C from the front side, and first to fourth lens frames 61 to 64 which respectively maintain the relevant lens groups L1 to L4. In addition, the second optical system 7 includes a non-spherical reflecting mirror 71.

The optical projection device 5 optically processes the image light which is incident from the fourth lens group L4 in the first optical system 6, emits the image light from the first lens group L1 to the reflecting mirror 71 of the second optical system 7, and reflects the emitted image light in the reflecting mirror 71 and emits the image light as the projection light to an upper direction of the first lens group L1.

The housing main body 51A of the optical projection housing 51 includes a flange 511 which is disposed at an incident-side end, a first accommodation portion 512 which extends from the flange 511 to the front side, and a second accommodation portion 513 which extends toward the first accommodation portion 512 and is widening toward the front side. The flange 511 is formed in a rectangular shape in a plan view, and the electro-optic device 35 is fixed to a rear end surface thereof. In addition, the flange 511 includes an insertion hole 5111 at a center, and a rear side of a fourth lens frame 64 which maintains the fourth lens group L4 is inserted thereinto.

The first accommodation portion 512 has a substantially cylindrical shape, is formed in a generally half-cylindrical shape in which an upper side is cut based on a central axis, and accommodates the first optical system 6 therein. In addition, a fixing portion 5121, which is used to fix the optical projection device 5 to a fixing member (not shown in the drawing) inside the projector 1, is formed to extend in the left and right directions on the front side and the rear side of an upper end of the first accommodation portion 512.

The second accommodation portion 513 has a cylindrical shape which is widening toward the front side, and is formed in a generally half-cylindrical shape (semicircular truncated cone shape) in which an upper side is cut based on the central axis. A front-side end 5131 of the second accommodation portion 513 is open, and the reflecting mirror 71 is installed on an inner surface which is close to the front-side end 5131.

As illustrated in FIG. 4, the cover 51B of the optical projection housing 51 is provided at an upper portion of the housing main body 51A to cover from the front-side end 5131 of the second accommodation portion 513 to the extent of the front side of the first accommodation portion 512. The cover 51B generally includes a light transmission plate maintenance portion 521 which maintains the rectangular-shaped transparent light transmission plate 53 that passes the projection light reflected in the reflecting mirror 71 at an angle approximately orthogonal to a projection optical axis corresponding to a line binding a center of projection light flux, and a slope 522 which is formed at an angle that does not block the projection light passing through the light transmission plate 53. Meanwhile, the cover 51B is fixed to an upper end of the housing main body 51A by screws. Meanwhile, in a case where the cover 51B is fixed to housing main body 51A, it is possible to prevent leakage of light or the like, which is emitted from the first optical system 6, to the outside.

As illustrated in FIGS. 3 to 6, the guide barrel 65 includes a front-side cylinder portion 651 and a rear-side cylinder portion 652. A straight groove 6521, which is notched along a direction of the optical axis C from the front side to the rear side, is formed to pass through a side surface of the rear-side cylinder portion 652. Meanwhile, three straight grooves 6521 are formed on a side surface of the rear-side cylinder portion 652 in a circumferential direction around the optical axis C at regular intervals of an angle of 120°. Four fixing portions 6522, which have screw holes (not shown in the drawing) for fixing the first adjusting barrel 67 that will be described later, are formed at a rear end of the rear-side cylinder portion 652. In addition, one fixing portion 6523, which has screw holes (not shown in the drawing) for fixing an adjusting and fixing member 70 which will be described later, is formed to project in a concentric circle shape in the vicinity of a rear-side end of the rear-side cylinder portion 652.

In the front-side cylinder portion 651, a notch portion 6511, which has an upper portion that is notched, is formed in accordance with the slope 522 of the cover 51B that is formed to not interfere in the projection light from the reflecting mirror 71. The front-side cylinder portion 651 covers outer circumferential sides of the first lens frame 61 and the second lens frame 62 which have forms projecting from the rear-side cylinder portion 652 toward the front side. Meanwhile, the guide barrel 65 is fixed to the inside of the housing main body 51A by screws.

The cam barrel 66 is formed in a cylindrical shape, has an inner side to which the rear-side cylinder portion 652 of the guide barrel 65 is inserted, and is capable of rotating around the optical axis C with respect to the guide barrel 65. The cam barrel 66 includes the maintenance portion 661 which is formed in a cylindrical shape. A guide groove 662, which is notched along the direction of the optical axis C from the front-side end to the rear side, and cam grooves 663, 664, and 665, which are formed on specified paths and prescribe movement operations of the first to third lens groups L1 to L3, are formed on an inner circumferential surface of the maintenance portion 661. Meanwhile, the guide groove 662 and the three cam grooves 663, 664, and 665 are formed in a circumferential direction of the maintenance portion 661 around the optical axis C at regular intervals of an angle of 120°.

A fixing portion 666, which fixes a lever member that is not shown in the drawing, is formed on an outer circumferential surface of the cam barrel 66. In a case where the focus adjustment is performed, it is possible to rotationally move and adjust the cam barrel 66 with respect to the guide barrel 65 by rotationally moving the lever member.

As illustrated in FIG. 4, the first lens group L1, the second lens group L2, and the third lens group L3 are formed to be respectively maintained in the first lens frame 61, the second lens frame 62, and the third lens frame 63, to be inserted into the guide barrel 65, and to be able to move along the optical axis C. Cam pins 61P, 62P, and 63P are formed in the respective lens frames 61, 62, and 63, and the cam pins 61P, 62P, and 63P are engaged with the straight grooves 6521 of the guide barrel 65 and the cam grooves 663, 664, and 665 of the cam barrel 66.

Furthermore, the respective lens frames 61, 62, and 63 move along the direction of the optical axis C in such a way that the cam pins 61P, 62P, and 63P are guided to intersection points of the straight grooves 6521 and the cam grooves 663, 664, and 665 due to the rotational movement of the cam barrel 66.

As illustrated in FIG. 4, the fourth lens group L4 is maintained in the fourth lens frame 64. Furthermore, the fourth lens frame 64 is inserted into the guide barrel 65 through the first adjusting barrel 67, a second adjusting barrel 68, and an adjusting ring 69. The optical projection device 5 performs focus adjustment on the image light in a case where the lens groups L1, L2, and L3 move.

Hereinafter, configurations and assembling of the respective members which are included in the optical projection unit 50 will be described.

### [Configurations of First Lens Group L1 and First Lens Frame 61]

The first lens group L1 includes one non-spherical lens (referred to as a first lens L11), and is cut to be horizontal to the optical axis C in a specified position on an upper side of the optical axis C. In addition, the left and right directions of the first lens L11 are cut to be orthogonal to the specified position. The first lens frame 61 includes a maintenance portion 611, which maintains the first lens group L1, and the cam pins 61P. The maintenance portion 611 is generally formed in a cylindrical shape. Meanwhile, a slope 613 is formed on an upper portion of the outer circumferential surface on the front side of the maintenance portion 611, together with the slope 522 of the cover 51B. An accommodation portion 614, which accommodates the first lens L11, is formed on a front-side end surface of the maintenance portion 611.

Meanwhile, the cam pins 61P are formed to project to the outside in a direction which crosses the optical axis C from the outer circumferential surface in the vicinity of the rear-side end of the maintenance portion 611. Three cam pins 61P are provided in the circumferential direction around the optical axis C at regular intervals of an angle of 120°. The cam pins 61P are formed in a tapered shape which is a cylindrical shape whose tip portion becomes thin.

### [Configurations of Second Lens Group L2 and Second Lens Frame 62]

The second lens group L2 includes a cemented lens in which the second lens L21 and the third lens L22 are cemented, and is cut to be horizontal to the optical axis C from a specified distance on the upper side of the optical axis C. Similarly to the first lens frame 61, the second lens frame 62 includes a maintenance portion 621, which maintains the second lens group L2, and three cam pins 62P. A step portion 623 is formed in accordance with the slope 522 of the cover 51B on an upper portion of the outer circumferential surface of the maintenance portion 621 on the front side. Meanwhile, the second lens group L2 is maintained through thermal caulking on a front-side end inner circumferential surface, on which the step portion 623 of the maintenance portion 621 is formed.

### [Configuration of Third Lens Group L3 and Third Lens Frame 63]

The third lens group L3 includes three lenses, that is, a fourth lens L31, a fifth lens L32, and a sixth lens L33, and the fourth lens L31 and the fifth lens L32 are the cemented lenses which are cemented. Similarly to the first lens frame 61, the third lens frame 63 includes a maintenance portion 631, which maintains the third lens group L3, and three cam pins 63P. The third lens group L3 is maintained through thermal caulking in a specified position on an inner circumferential surface of a front side of the maintenance portion 631.

### [Configuration of Fourth Lens Group L4 and Fourth Lens Frame 64]

As illustrated in FIGS. 4 and 6, the fourth lens group L4 includes nine lenses, that is, seventh to fifteenth lenses L41 to L49. The fourth lens frame 64 includes a first division frame 641 and a second division frame 642. The first division frame 641 maintains the seventh lens L41 and the eighth lens L42, and the second division frame 642 maintains ninth to fifteenth lenses L43 to L49. The fourth lens frame 64 includes a flange 6421 which is formed to project in a direction that crosses the optical axis C on an outer circumferential surface in the middle of the second division frame 642. The first division frame 641 and the second division frame 642 perform optical axis adjustment (alignment) after fixing lenses to the respective barrels. Thereafter, the first division frame 641 and the second division frame 642 are integrated by being fixed using an adhesive. Meanwhile, the fourth lens frame 64 will be described in detail later.

### [Assembling of Guide Barrel 65, Third Lens Frame 63, Second Lens Frame 62, and First Lens Frame 61]

As illustrated in FIGS. 4 to 6, the cam pins 63P of the third lens frame 63 are engaged with the straight grooves 6521 of the guide barrel 65 from the front side, and the third lens frame 63 is inserted into an inner surface of the rear-side cylinder portion 652. Subsequently, similarly to the third lens frame 63, the cam pins 62P are engaged with the straight grooves 6521 of the second lens frame 62 from the front side, and the second lens frame 62 is inserted into the inner surface of the rear-side cylinder portion 652. Therefore, as illustrated in FIG. 4, an area of the maintenance portion 631 (a front-side area of the maintenance portion 631), which maintains the third lens group L3 of the third lens frame 63, is in a state of being inserted into an inner circumferential surface of a rear side of the maintenance portion 621 of the second lens frame 62.

Subsequently, as illustrated in FIG. 4, similarly to the second lens frame 62, the cam pins 61P of the first lens frame 61 are engaged with the straight grooves 6521 from the front side, and the first lens frame 61 is inserted into the inner surface of the rear-side cylinder portion 652. Therefore, an area of the maintenance portion 621 (a front-side area of the maintenance portion 621), which maintains the second lens group L2 of the second lens frame 62, is in a state of being inserted into an inner circumferential surface of the maintenance portion 611 of the first lens frame 61.

Therefore, the first lens frame 61, the second lens frame 62, and the third lens frame 63 are in a state in which the cam pins 61P, 62P, and 63P are maintained by being engaged with the guide barrel 65. In addition, the tip portions of the cam pins 61P, 62P, and 63P are in a state of projecting from the straight grooves 6521 of the guide barrel 65.

### [Assembling of Guide Barrel 65 and Cam Barrel 66]

The cam barrel 66 guides the tip portions of the projecting cam pins 61P, 62P, and 63P of the first lens frame 61, the second lens frame 62, and the third lens frame 63, which are maintained by being engaged with the guide barrel 65, to the guide groove 662, and thus the guide barrel 65 is inserted from the front side of the cam barrel 66. Therefore, the rear-side cylinder portion 652 of the guide barrel 65 is inserted into the cam barrel 66. The cam barrel 66 is capable of rotationally moving around the optical axis C with respect to the guide barrel 65.

### [Adjustment of Fourth Lens Frame 64 in Optical Projection Device 5]

Although the fourth lens frame 64 (fourth lens group L4) is a lens group which is fixed in the first optical system 6, it is possible to adjust (perform back-focus adjustment) a position for the movable first lens frame 61 to the third lens frame 63 (first to third lens groups L1 to L3) by rotationally moving the fourth lens frame 64 with respect to the guide barrel 65. Meanwhile, a member, which causes the fourth lens frame 64 to rotationally move, includes the first adjusting barrel 67, the second adjusting barrel 68, and the adjusting ring 69, and a member, which fixes the fourth lens frame 64 to the guide barrel 65 in an adjustment position after the adjustment, includes the adjusting and fixing member 70.

Meanwhile, in the embodiment, it is possible to solely perform position adjustment (optical axis adjustment) by the fourth lens frame 64 according to the invention. The configuration and the adjustment will be described later.

### [Configuration of First Adjusting Barrel 67]

As illustrated in FIGS. 5 and 6, the first adjusting barrel 67 includes a cylindrical maintenance portion 671, and a flange 672 which has a rectangular shape on an outer circumferential surface of the maintenance portion 671 in planar view. A screw groove 6711 is formed on an inner surface of the maintenance portion 671. Hole portions 6721 are formed at respective four corner portions of the flange 672. The first adjusting barrel 67 is fixed by inserting a front side of the maintenance portion 671 from a rear end side of the rear-side cylinder portion 652 of the guide barrel 65, causing the flange 672 to be in contact with the rear end of the rear-side cylinder portion 652, and screwing screws SC1, which are inserted into the hole portions 6721 of the flange 672, into screw holes (not shown in the drawing) of a fixing portion 6522 included in the rear end of the rear-side cylinder portion 652.

### [Configuration of Second Adjusting Barrel 68]

As illustrated in FIG. 6, the second adjusting barrel 68 includes a cylindrical maintenance portion 681, a convex portion 682 which is formed at the rear end of an outer circumferential surface of the maintenance portion 681, fixing projections 683 which are formed on a front side of the convex portion 682 on the outer circumferential surface, and a concave portion 684 which is formed at the rear end of an inner circumferential surface of the maintenance portion 681. The fixing projections 683 are parallel to the optical axis C, are formed to project in a direction crossing the optical axis C, and are provided in a circumferential direction around the optical axis C at regular intervals. In addition, a screw groove 6821 is formed on an outer circumferential surface of the convex portion 682, and a screw portion 6811 is formed on a front-side outer circumferential surface of the maintenance portion 681.

### [Configuration of Adjusting Ring 69]

As illustrated in FIG. 6, the adjusting ring 69 includes a ring-shaped maintenance portion 691, and a fixing portion 692 which extends to face the optical axis C from the rear end of the maintenance portion 691 and includes an opening 6921. In addition, a screw portion 6911 is formed on an inner circumferential surface of the maintenance portion 691.

### [Configuration of Adjusting and Fixing Member 70]

As illustrated in FIGS. 5 and 6, the adjusting and fixing member 70 is generally formed in a rectangular shape in a plan view, and includes a fixing main body 701 which is formed at a curvature along an outer circumferential surface of the fixing portion 6523 of the guide barrel 65, and a fixing piece 702 which extends on a rear side from a center of the rear end of the fixing main body 701 and is formed to be lower on a side of the optical axis C. A slit-shaped hole portion 7011 is formed in the fixing main body 701 along a radial direction. At a rear-side end of the fixing piece 702, a notch portion 7021, which is notched to clamp the fixing projections 683 of the second adjusting barrel 68 in a rotational movement direction, is formed.

[Assembling of Fourth Lens Frame 64 with Guide Barrel 65]

Initially, the fourth lens frame 64, on which the optical axis adjustment ends, is inserted from the rear side of the second adjusting barrel 68, and the flange 6421 of the fourth lens frame 64 is positioned in the concave portion 684 of the second adjusting barrel 68. Subsequently, the adjusting ring 69 (opening 6921) is inserted from the rear side of the fourth lens frame 64, and the screw portion 6911 of the adjusting ring 69 is screwed to the screw groove 6821 of the second adjusting barrel 68. Therefore, the fourth lens frame 64 is fixed by being interposed between the second adjusting barrel 68 and the adjusting ring 69.

Subsequently, the fourth lens frame 64, which is interposed between the second adjusting barrel 68 and the adjusting ring 69, is inserted into the maintenance portion 671 of the first adjusting barrel 67, which is fixed to a rear-side end of the guide barrel 65, from the front side. Furthermore, in a case where the screw portion 6811 of the second adjusting barrel 68 is screwed to the screw groove 6711 of the first adjusting barrel 67, the fourth lens frame 64 is fixed to the guide barrel 65.

With the above-described assembling, the optical projection unit 50 is assembled. Meanwhile, in order to perform back-focus adjustment which will be described later, the optical projection unit 50 is fixed to the optical projection housing 51 (housing main body 51A), and, thereafter, the back-focus adjustment is performed.

### [Back-Focus Adjustment of Fourth Lens Frame 64]

As described above, it is possible to rotationally move the fourth lens frame 64 (fourth lens group L4) with respect to the guide barrel 65 (first adjusting barrel 67). In the embodiment, in a case where the fourth lens frame 64 is rotationally moved, it is possible to perform the back-focus adjustment of the optical projection device 5. In the back-focus adjustment, light (image light), which is incident from an image side, is projected through the optical projection device 5, and the fourth lens frame 64 is rotationally moved while the projected projection image is visually recognized.

Meanwhile, in a case where the fourth lens frame 64 is rotationally moved, the fourth lens frame 64 is rotationally moved while the maintenance portion 691 of the adjusting ring 69 is grasped. In a case where the adjusting ring 69 is rotationally moved, the second adjusting barrel 68 (screw portion 6811) varies a screwing state with respect to the first adjusting barrel 67 (screw groove 6711). As a result, the second adjusting barrel 68, the adjusting ring 69, and the fourth lens frame 64 are rotationally moved with respect to the first adjusting barrel 67 (guide barrel 65).

### [Fixing of Fourth Lens Frame 64]

In a case where the back-focus adjustment performed by the fourth lens frame 64 ends, subsequently, the fourth lens frame 64 is fixed to the guide barrel 65 by the adjusting and fixing member 70. Specifically, the fixing main body 701 of the adjusting and fixing member 70 is installed in a specified place of the fixing portion 6523 of the guide barrel 65. At this time, a state, in which the notch portion 7021 clamps any one of the fixing projections 683 of the second adjusting barrel 68, is made. Meanwhile, in the embodiment, in a case where the fourth lens frame 64 is rotationally moved, a rotational movement pitch is not arbitrarily and is set to a pitch of the fixing projections 683 (a pitch of 30°).

Subsequently, in a state in which the notch portion 7021 of the adjusting and fixing member 70 clamps the fixing projection 683 of the second adjusting barrel 68, a screw SC2 is inserted into the hole portion 7011, and is screwed to the screw hole included in the fixing portion 6523 of the guide barrel 65. Therefore, it is possible to fix the fourth lens frame 64 to the guide barrel 65.

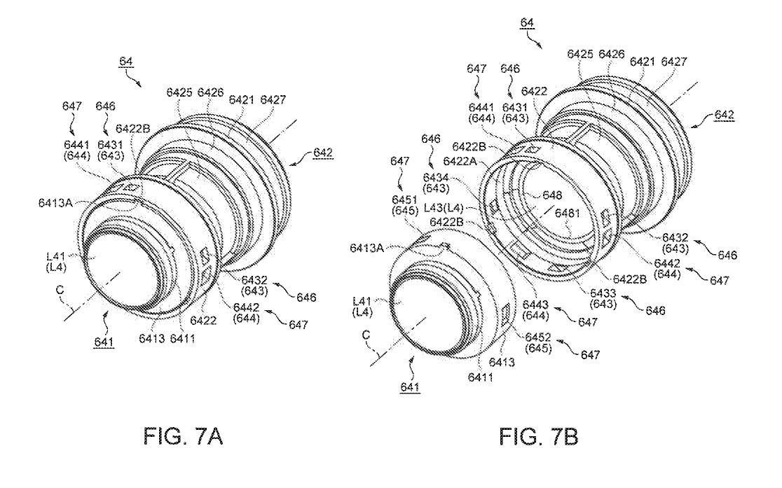

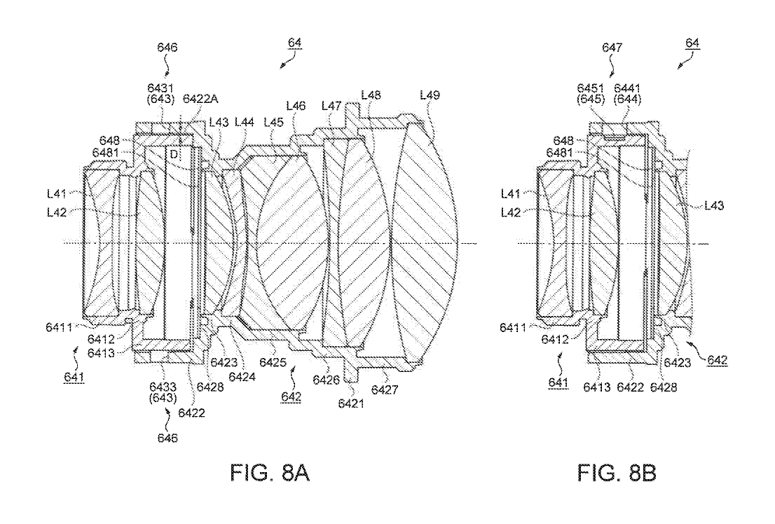

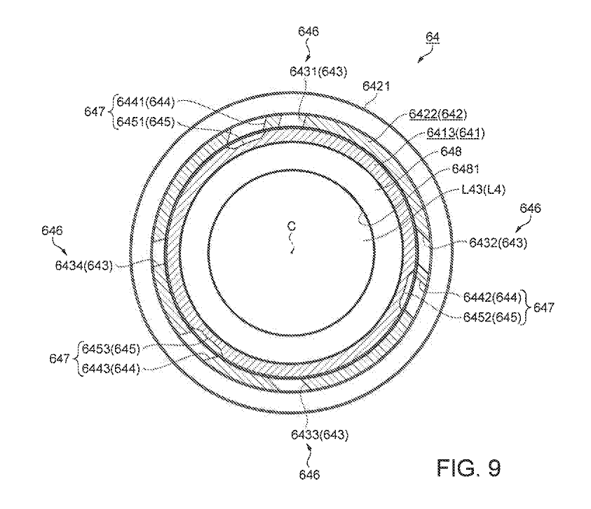

FIG. 7 is a perspective diagram illustrating the fourth lens group L4 and the fourth lens frame 64. Meanwhile, FIG. 7 (a) is a perspective diagram viewed from the front side, and FIG. 7(b) is a perspective diagram illustrating a state, in which the fourth lens frame 64 is divided into the first division frame 641 and the second division frame 642, viewed from the front side. FIG. 8 is a sectional diagram illustrating the fourth lens group L4 and the fourth lens frame 64 in the direction of the optical axis C. Meanwhile, FIG. 8(a) illustrates a section of the adjustment portion 646 which includes an adjusting barrel 6413 and an adjusting maintenance barrel 6422, and FIG. 8(b) illustrates a section of a fixing portion 647 which includes the adjusting barrel 6413 and the adjusting maintenance barrel 6422. FIG. 9 is a sectional diagram illustrating the fourth lens group L4 and the fourth lens frame 64 in the direction which is orthogonal to the optical axis C. Meanwhile, FIG. 9 illustrates a section which is orthogonal to the optical axis C based on the adjustment portion 646 and the fixing portion 647. The fourth lens group L4 and the fourth lens frame 64 will be described in detail with reference to FIGS. 4 to 9.

### [Configuration of Fourth Lens Group L4]

The fourth lens group L4 includes nine lenses from the seventh lens L41 to the fifteenth lens L49. Specifically, the fourth lens group L4 includes the seventh lens L41, which is formed of a non-spherical lens, and the eighth lens L42. In addition, the fourth lens group L4 includes the ninth lens L43, the tenth lens L44 which is formed of a non-spherical lens, the eleventh lens L45 and the twelfth lens L46 which are formed of a cemented lens, the thirteenth lens L47 which is similarly formed of a cemented lens, the fourteenth lens L48, and the fifteenth lens L49.

### [Configuration of Fourth Lens Frame 64]

The fourth lens frame 64 is formed by being divided into two frames, that is, the first division frame 641 and the second division frame 642 on the front side and the rear side. In the embodiment, the fourth lens frame 64 is divided into two frames, that is, the first division frame 641 and the second division frame 642 between a diaphragm 648, which will be described later, and the eighth lens L42 which is adjacent to the diaphragm 648.

The first division frame 641 is a lens frame which is formed in a cylindrical shape on a front side of the diaphragm 648. The first division frame 641 is formed with a seventh lens accommodation portion 6411 which accommodates the seventh lens L41 on a front-side inner circumferential side, an adjusting barrel 6413 which is formed in a cylindrical shape that has a larger appearance on a rear side of the seventh lens accommodation portion 6411, and an eighth lens accommodation portion 6412 which accommodates the eighth lens L42 inside of the adjusting barrel 6413. Meanwhile, the seventh lens L41 is inserted into the seventh lens accommodation portion 6411 from the front side, and is fixed through the thermal caulking. The eighth lens L42 is inserted into the eighth lens accommodation portion 6412 from the rear side, and is fixed through the thermal caulking.

The second division frame 642 is a lens frame which is formed in the cylindrical shape on the rear side that includes the diaphragm 648. The second division frame 642 is formed with the adjusting maintenance barrel 6422 which is provided to insert the adjusting barrel 6413 of the first division frame 641 into the front side, a diaphragm fixing portion 6428 which fixes the diaphragm 648 inside of the adjusting maintenance barrel 6422, and a ninth lens accommodation portion 6423 which accommodates the ninth lens L43 on a rear side of the diaphragm fixing portion 6428. Meanwhile, before the diaphragm 648 is fixed to the diaphragm fixing portion 6428, the ninth lens L43 is inserted into the ninth lens accommodation portion 6423 from the front side, and is fixed through the thermal caulking.

The diaphragm 648 is formed in a disk shape, and includes a circular opening 6481 which is formed with a specified diameter from a center. In the embodiment, the diaphragm 648 is formed by a metal plate. The diaphragm 648 is a member which is placed between the eighth lens L42 and the ninth lens L43 in the first optical system 6. Furthermore, the diaphragm 648 is fixed to be in contact with the diaphragm fixing portion 6428 from the front side. Meanwhile, the diaphragm 648 causes effective light to pass through the opening 6481 with respect to light, which is emitted after being optically processed by the ninth to fifteenth lenses L43 to L49, and shades unnecessary light in areas other than the opening 6481.

In addition, the second division frame 642 is formed with a tenth lens accommodation portion 6424 which is formed on a rear side of the ninth lens accommodation portion 6423 in a cylindrical shape and which accommodates the tenth lens L44, and an eleventh/twelfth lens accommodation portion 6425 which is formed on the rear side of the tenth lens accommodation portion 6424 in a cylindrical shape that has a larger diameter than that of the tenth lens accommodation portion 6424 and which accommodates the cemented lens of the eleventh lens L45 and the twelfth lens L46. Meanwhile, the tenth lens L44 is inserted into the tenth lens accommodation portion 6424 from the rear side. In the state, the cemented lens (the eleventh lens L45 and the twelfth lens L46) is inserted into the eleventh/twelfth lens accommodation portion 6425 from the rear side, and both lenses are fixed in such way that the cemented lens is in contact with the tenth lens L44 and presses the tenth lens L44 through the thermal caulking.

In addition, in the second division frame 642, a thirteenth/fourteenth lens accommodation portion 6426, which accommodates the cemented lens of the thirteenth lens L47 and the fourteenth lens L48, is formed on the rear side of the eleventh/twelfth lens accommodation portion 6425 in a cylindrical shape which has a larger diameter than that of the eleventh/twelfth lens accommodation portion 6425. Meanwhile, the cemented lens of the thirteenth lens L47 and the fourteenth lens L48 is inserted into the thirteenth/fourteenth lens accommodation portion 6426 from the rear side and is fixed through the thermal caulking.

In addition, in the second division frame 642, a fifteenth lens accommodation portion 6427, which accommodates the fifteenth lens L49, is formed in the most rear side on the rear side of the thirteenth/fourteenth lens accommodation portion 6426 in a cylindrical shape which has a larger diameter than that of the thirteenth/fourteenth lens accommodation portion 6426. Meanwhile, the fifteenth lens L49 is inserted into the fifteenth lens accommodation portion 6427 from the rear side, and is fixed through the thermal caulking. Meanwhile, the flange 6421 is formed at the boundary between the thirteenth/fourteenth lens accommodation portion 6426 and the fifteenth lens accommodation portion 6427 as described above.

### [Configurations of Adjusting Barrel 6413 and Adjusting Maintenance Barrel 6422]

In the adjusting maintenance barrel 6422 of the second division frame 642, pierced adjusting hole portions 643, which are used to adjust the first division frame 641, are formed in the direction crossing the optical axis C from the outer circumferential surface. The adjusting hole portions 643 is included in the adjustment portion 646 which performs the optical axis adjustment (adjustment for coincidence of the optical axis) of the first division frame 641 (the seventh lens L41 and the eighth lens L42) with respect to the second division frame 642 (the ninth to fifteenth lens L43 to L49) of the fourth lens frame 64 (fourth lens group L4). Meanwhile, the adjustment portion 646 is a portion which maintains the first division frame 641 (adjusting barrel 6413) and the second division frame 642 (adjusting maintenance barrel 6422) such that the position of the optical axis C can be adjusted.

As illustrated in FIG. 7, the adjusting hole portions 643 are formed in approximately rectangular shapes in planar view. In addition, as illustrated in FIG. 9, four adjusting hole portions 643 are formed in a circumferential direction (radial direction) around the optical axis C at regular intervals of an angle of 90°. The four adjusting hole portions 643 include adjusting hole portions 6431, 6432, 6433, and 6434 in a clockwise direction in FIG. 9.

In addition, the adjusting hole portions 643 are respectively formed in positions facing each other across the optical axis C. Specifically, the adjusting hole portions 6431 and 6433 are formed in positions facing each other across the optical axis C, and the adjusting hole portions 6432 and 6434 are formed in positions facing each other across the optical axis C.

Meanwhile, in a case where the adjusting hole portions 643 are formed through the direction crossing the optical axis C from the outer circumferential surface, areas of an outer circumferential surface of the adjusting barrel 6413, which face the adjusting hole portions 643 and are positioned on an inner circumferential surface side of the adjusting maintenance barrel 6422, are in a state of being exposed through the adjusting hole portions 643.

The second division frame 642 is molded through injection molding, and molding of the adjusting hole portions 643 has a mold structure which is taken out in three directions using slide core. Therefore, as illustrated in FIG. 9, sectional shapes of the adjusting hole portions 643 become inclined shapes without being parallel sections across the optical axis C.

Meanwhile, as requirements for the adjusting hole portions 643, areas, which are necessary for insertion, and pressing force, which causes directions of pressed pressure due to the facing jigs to face the optical axis C, are necessary in a case where adjusting jigs are inserted into the adjusting hole portions 643 which are facing each other. Therefore, there is no problem if the requirements are satisfied even in a case where the sectional shapes are inclined.

In addition, as illustrated in FIGS. 7 and 8, a projected surface 6422A, which projects toward the side of the optical axis C and has a smaller diameter than that of the inner circumferential surface, is formed on an inner circumferential surface of the adjusting maintenance barrel 6422. The outer circumferential surface of the adjusting barrel 6413 is formed to have a diameter which is smaller than the diameter of the projected surface 6422A by a radius D.

Fixing hole portions 644, which pass in the direction of the optical axis C from the outer circumferential surface, are formed on the adjusting maintenance barrel 6422 of the second division frame 642. The fixing hole portions 644 are included in the fixing portion 647 which fixes the first division frame 641 and the second division frame 642 in which the adjustment ends.

As illustrated in FIG. 7, the fixing hole portions 644 are formed in approximately rectangular shapes in planar view. In addition, as illustrate in FIG. 9, three fixing hole portions 644 are formed in the circumferential direction (radial direction) around the optical axis C at regular intervals of an angle of 120°. The three fixing hole portions 644 include fixing hole portions 6441, 6442, and 6443 in the clockwise direction in FIG. 9.

Meanwhile, fixing groove portions 645, which face the fixing hole portions 644, are formed on the outer circumferential surface of the adjusting barrel 6413. Meanwhile, the fixing groove portions 645 are included in the fixing portion 647. As illustrated in FIG. 7, the fixing groove portions 645 are formed in approximately rectangular shapes in planar view. Meanwhile, in FIG. 9, the fixing groove portions 645 include fixing groove portions 6451, 6452, and 6453 corresponding to the fixing hole portions 6441, 6442, and 6443.

### [Adjusting Barrel 6413 and Adjusting Maintenance Barrel 6422 Adjusting Method]

The fourth lens frame 64 performs the optical axis adjustment using the two frames, that is, the first division frame 641 and the second division frame 642 acquired through the division. Specifically, the fourth lens frame 64 performs adjustment which causes the optical axis C of the second division frame 642, in which the diaphragm 648 and the ninth to fifteenth lenses L43 to L49 are installed, to coincide with the optical axis C of the first division frame 641 in which the seventh lens L41 and the eighth lens L42 are installed.

Initially, fixing jigs (not shown in the drawing) are installed such that the front side of the second division frame 642 becomes an upper direction. Subsequently, the adjusting barrel 6413 of the first division frame 641 is inserted into an inner surface side of the adjusting maintenance barrel 6422 of the second division frame 642 from the upper direction. In a case of the insertion, the installation projections 6413A, which are formed at the front-side end of the adjusting barrel 6413, are inserted into installation reception grooves 6422B which are formed at the front-side end of the adjusting maintenance barrel 6422.

In the embodiment, a comatic aberration measurement machine is used as an adjusting measurement machine. In addition, in the embodiment, a jig, which includes a probe (not shown in the drawing) that includes a compression coil spring to be inserted into one side hole portion (for example, the adjusting hole portion 6431) of the adjusting hole portions 643 facing each other, and a probe (not shown in the drawing) that does not include a compression coil spring to be inserted into another side hole portion (for example, the adjusting hole portion 6433), is used as the adjusting jig. Similarly, a jig, which includes a probe (not shown in the drawing) that includes a compression coil spring to be inserted into one side hole portion (for example, the adjusting hole portion 6432) of the adjusting hole portions 643 facing each other, and a probe (not shown in the drawing) that does not include a compression coil spring to be inserted into another side hole portion (for example, the adjusting hole portion 6434), is used.

Furthermore, a state is made in which probes are respectively inserted into the adjusting hole portions 643 and respectively face and press the exposed outer circumferential surface of the adjusting barrel 6413. Furthermore, in a case where a pressing amount (movement amount) of the probe that does not include the compression coil spring is varied, adjustment is performed such that the optical axes C coincide with each other by moving the position of the first division frame 641 with respect to the second division frame 642.

### [Adjusting Barrel 6413 and Adjusting Maintenance Barrel 6422 Fixing Method]

In a case where the optical axis adjustment ends, the first division frame 641 and the second division frame 642 are fixed in a state in which the optical axis is adjusted. In the embodiment, fixing is performed using an ultraviolet ray-curing type adhesive. Specifically, a tip portion of a dispenser filled with the adhesive is inserted into three fixing hole portions 644 (6441, 6442, and 6443) of the second division frame 642 with respect to the fourth lens frame 64 in which the optical axis adjustment ends, and the adhesive is injected into the respective fixing groove portions 645 (6451, 6452, and 6453), which are formed to face the fixing hole portions 644, of the first division frame 641.

Therefore, in a case where the adhesive is injected into the fixing groove portions 645 and peripheral gaps thereof, the adhesive is coated in the fixing groove portions 645, the projected surface 6422A, the fixing hole portions 644, and the like. Thereafter, in a case where ultraviolet rays are irradiated, the adhesive is cured. As described above, the first division frame 641 and the second division frame 642 are fixed using the adhesive, and the fourth lens frame 64 is integrated.

Meanwhile, the fourth lens frame 64, which is integrated in such a way that the first division frame 641 and the second division frame 642 are fixed after the optical axis adjustment ends, is inserted into the second adjusting barrel 68, and is fixed by being interposed between the second adjusting barrel 68 and the adjusting ring 69 in a subsequent process. In addition, the fourth lens frame 64 which is interposed between the second adjusting barrel 68 and the adjusting ring 69 is fixed to the guide barrel 65 through the first adjusting barrel 67.

Meanwhile, the optical projection unit 50, which is assembled while including the fourth lens frame 64, is fixed to the housing main body 51A, in which the reflecting mirror 71 is installed, by screws. Thereafter, in a case where the cover 51B, on which the light transmission plate 53 is installed, is fixed on an upper portion of the housing main body 51A by screws, assembling of the optical projection device 5 is completed. Meanwhile, thereafter, as described above, the back-focus adjustment is performed by rotationally moving the entire fourth lens frame 64. In the end, although description is omitted, the aberration, such as the curvature of field of the projection image, is adjusted by adjusting the position of the first lens group L1 (first lens L11). Therefore, the assembling and adjustment of the optical projection device 5 end, and the optical projection device 5 is completed.

According to the above-described embodiment, advantages below are acquired.

According to the optical projection device 5 of the embodiment, in the fourth lens group L4 which includes the diaphragm 648, the fourth lens frame 64 is divided into the first division frame 641 and the second division frame 642 between the diaphragm 648 and the eighth lens L42 which is adjacent to the diaphragm 648. Meanwhile, the diaphragm 648 is a place where light flux, which is incident from the image side, is most spread, and, in addition, highly-sensitive lenses are provided in front and rear of the diaphragm 648. Therefore, in a case where the fourth lens frame 64 is divided between the diaphragm 648 and the lens (in the embodiment, the eighth lens L42) which is adjacent to the diaphragm 648, the front and rear lenses of the diaphragm 648 are separated. In a case where the optical axis adjustment (so-called alignment) is performed using the adjustment portion 646, the diaphragm becomes a most efficient place for controlling the light flux. As described above, in a case where the optical axis adjustment is performed by dividing the fourth lens frame 64 between the diaphragm 648 and the lens which is adjacent to the diaphragm 648, high definition adjustment is performed, and thus it is possible to correct the aberration due to irregularities and deviation of the installation positions of the lenses. In addition, it is possible to prevent lens sensitivity from being deteriorated. In a case where it is possible to prevent defects, such as deterioration in contrast and blur, it is possible to improve qualities of a projected image. Accordingly, it is possible to realize the optical projection device 5 which effectively suppresses variation in aberration due to the irregularities in the installation positions of the lenses. With the optical projection device 5, it is possible to project high definition projection image whose image quality is improved.

According to the optical projection device 5 of the embodiment, the adjusting jigs (probes) are inserted into the plurality of adjusting hole portions 643, which exist in the outer circumferential surface of the second division frame 642 (adjusting maintenance barrel 6422), and are caused to be in contact with the exposed outer circumferential surface of the first division frame 641 (adjusting barrel 6413). Furthermore, the first division frame 641 is moved with respect to the second division frame 642 by moving the jigs. Therefore, it is possible to perform adjustment which makes the optical axis C of the second division frame 642 coincide with the optical axis C of the first division frame 641. Accordingly, it is possible to effectively suppress the variation in aberrations due to the irregularities in installation positions of the lenses (the seventh lens L41, the eighth lens L42, and the ninth to fifteenth lenses L43 to L49).

According to the optical projection device 5 of the embodiment, the adjusting hole portions 643 are formed in positions facing each other across the optical axis C. Therefore, in a case where the optical axis adjustment is performed, it is possible to maintain the first division frame 641 in a balanced manner using the jigs (probes), and it is possible to stably move (adjust) the first division frame 641. Therefore, it is possible to perform high definition adjustment.

According to the optical projection device 5 of the embodiment, the fixing portion 647, which fixes the first division frame 641 and the second division frame 642, is included. Therefore, in a case where the adhesive is injected from the fixing hole portions 644 of the second division frame 642, the adhesive is accumulated in the fixing groove portions 645 included in the first division frame 641, and thus it is possible to improve adhesive strength in such a way that an adhesive area is enlarged, and the adhesive, which is cured in the fixing groove portions 645, performs a function as a wedge, or the like.

According to the optical projection device 5 of the embodiment, the plurality of fixing hole portions 644 are formed approximately at regular intervals, and thus it is possible to perform balanced efficient fixing. Therefore, it is possible to improve qualities with respect to fall and vibration.

According to the optical projection device 5 of the embodiment, even in a case where the second optical system 7 (reflecting optical system), which includes the reflecting mirror 71, is included in the first optical system 6 (refracting optical system) as the optical projection system, it is possible to acquire the above-described effects.

According to the optical projection device 5 of the embodiment, in cases where the first optical system 6 and the second optical system 7 are provided as the optical projection system, the first to third lens group L1 to L3 are formed for the focus adjustment, and the short distance projection is performed, it is possible to suppress variation in aberration due to the focus adjustment to be small.

The projector 1 according to the embodiment includes the optical projection device 5, the light source device 31 which emits light, and the optical modulators (liquid crystal panels 351) which modulate light according to the image information. Since it is possible to effectively suppress the variation in aberrations by the optical projection device 5, it is possible to improve the quality of the projection image and project high definition projection image.

Meanwhile, the invention is not limited to the above-described embodiment, and can be realized by adding various modifications, improvements, and the like in a scope without departing from the gist of the invention. Modification examples will be described below.

In the optical projection device 5 according to the embodiment, the fourth lens frame 64, which accommodates the fourth lens group L4, is divided into the first division frame 641 and the second division frame 642 between the diaphragm 648 and the eighth lens L42 which is adjacent to the diaphragm 648. However, division may be performed between the diaphragm 648 and the lens which is adjacent to the diaphragm 648, and thus division may be performed between the diaphragm 648 and, for example, the ninth lens L43 (however, in a case of being established in optical design) which is adjacent to the diaphragm 648.

In the optical projection device 5 according to the embodiment, the fourth lens frame 64 which accommodates the fourth lens group L4 is divided into the first division frame 641 and the second division frame 642 between the diaphragm 648 and the eighth lens L42 which is adjacent to the diaphragm 648. However, the lens frame is divided in a specified position with respect to a fixed lens group in the plurality of lens group, one lens frame which is acquired through the division may include an adjustment portion which performs the optical axis adjustment with the other lens frame which is acquired through the division. Furthermore, in a case where the optical axis adjustment is performed using the adjustment portion, it is possible to adjust the highly-sensitive lens with high definition, it is possible to prevent the deterioration in the lens sensitivity due to irregularities in installation positions of the lenses, and it is possible to effectively suppress the variation in aberrations. Furthermore, since a fixed lens group, which is not influenced by eccentricity and inclination of the lens due to movement, is adjusted, it is possible to perform higher definition adjustment.

In the optical projection device 5 according to the embodiment, the fourth lens frame 64, which accommodates the fourth lens group L4, is divided into the first division frame 641 and the second division frame 642 between the diaphragm 648 and the eighth lens L42 which is adjacent to the diaphragm 648. However, the lens frame is divided in a specified position with respect to a lens group which is disposed on the most incident side of the image light in the plurality of lens groups, one lens frame, which is acquired through the division, may include an adjustment portion which performs the optical axis adjustment with the other lens frame which is acquired through the division. Furthermore, in a case where the optical axis adjustment is performed using the adjustment portion, it is possible to adjust the highly-sensitive lens with high definition, with the result that the deterioration in the lens sensitivity due to irregularities in installation positions of the lenses is suppressed, and thus it is possible to effectively suppress the variation in aberrations. Furthermore, since the lens group, on the most incident side in which spread of the light flux is small and which has high sensitivity of the installation position of each lens in the optical projection device, is generally adjusted, it is possible to perform higher definition adjustment.

In the optical projection device 5 according to the embodiment, the fourth lens frame 64 is divided into two frames, that is, the first division frame 641 and the second division frame 642. However, the fourth lens frame 64 may be divided into three or more frames.

In the optical projection device 5 according to the embodiment, the diaphragm 648 is formed as a separate body from the second division frame 642. However, the diaphragm 648 may be formed to be integrated with the second division frame 642. In other words, the diaphragm 648 may be formed such that a part of the second division frame 642 functions as the diaphragm 648.

In the optical projection device 5 according to the embodiment, in the fourth lens frame 64, two adjusting hole portions (the adjusting hole portions 6431 and the adjusting hole portions 6433, and the adjusting hole portions 6432 and the adjusting hole portions 6434) are formed to interpose the optical axis C and face each other in the second division frame 642 as adjusting hole portions 643. However, three adjusting hole portions may be formed around the optical axis C at regular intervals.

In the optical projection device 5 according to the embodiment, in the fourth lens frame 64, four adjusting hole portions 6431 to 6434 are formed in the second division frame 642. However, more adjusting hole portions may be formed.

In the optical projection device 5 according to the embodiment, in the fourth lens frame 64, the position of the first division frame 641 is adjusted with respect to the second division frame 642. However, the second division frame 642 may be adjusted with respect to the first division frame 641. In this case, modifications may be performed in such a way that the adjusting hole portions 643 and the fixing hole portions 644, which are formed in the second division frame 642, are formed in the first division frame 641, the appearance of the adjusting barrel 6413 of the first division frame 641 is formed to be larger than the appearance of the adjusting maintenance barrel 6422 of the second division frame 642, and the adjusting maintenance barrel 6422 is inserted into the inner surface side of the adjusting barrel 6413.

In the optical projection device 5 according to the embodiment, the adjusting hole portions 643, which become holes, are formed as the adjustment portion 646 included in the adjusting maintenance barrel 6422 of the second division frame 642 (fourth lens frame 64). However, the adjustment portion 646 is not limited to the hole, and may be formed as the adjusting notch portion which becomes the notch. This is similar to the fixing hole portions 644 as the fixing portion 647. The fixing portion 647 is not limited to the hole and may be formed as fixing notch portions.

In the optical projection device 5 according to the embodiment, the three fixing hole portions 644 are formed at regular intervals (in the circumferential direction (radial direction) around the optical axis C at an angle of 120°). However, the three fixing hole portions 644 may be provided in positions in which it is possible to effectively acquire adhesive strength which can tolerate shocks such as fall and vibration. In addition, two or more hole portions may be provided.

In the optical projection device 5 according to the embodiment, the adjusting barrel 6413 of the first division frame 641 (fourth lens frame 64) includes the groove portions (fixing groove portions 645) which face the fixing hole portions 644. However, the invention is not limited thereto, and the adhesive may directly coat the areas, which are exposed to face the fixing hole portions 644, on the outer circumferential surface of the adjusting barrel 6413 without providing the groove portions.

Although the optical projection device 5 according to the embodiment includes the second optical system 7 (reflecting mirror 71), the optical projection device 5 may not include the second optical system 7. In addition, although the optical projection device 5 according to the embodiment includes the focus adjusting optical system, it is possible to apply the optical projection device 5 to an optical system which includes zoom adjustment.

As illustrated in FIG. 1, the projector 1 according to the embodiment is installed on the wall surface W through the support device SD such that the bottom surface 1A becomes the upper side, and projects the projection image on the screen SC which is installed on the lower side of the projector 1. However, a way of installing the projector 1 is not limited. The projector 1 may be installed on a ceiling surface, a floor surface, a desk surface or the like, and may project the projection image to the screen SC installed on the wall surface W. In addition, the projector 1 may be installed on a desk surface, and may project the projection image on the same desk surface.

In the projector 1 according to the embodiment, the electro-optic device 35 uses a so-called three-plate method in which three optical modulators corresponding to R light, G light, and B light are used. However, the invention is not limited thereto, and an optical modulator using a single plate method may be used. In addition, an optical modulator for improving contrast may be additionally used.

In the projector 1 according to the embodiment, the electro-optic device 35 uses transmission-type optical modulators (transmission-type liquid crystal panels 351). However, the invention is not limited thereto, and reflection-type optical modulators may be used.

In the projector 1 according to the embodiment, the electro-optic device 35 uses the liquid crystal panels 351 as the optical modulators. However, the invention is not limited thereto, and, generally, any one which can modulate incident light flux based on an image signal may be used. For example, it is possible to use another type of optical modulator such as a micromirror-type optical modulator. Meanwhile, it is possible to use, for example, a Digital Micromirror Device (DMD) as the micromirror-type optical modulator.

In the projector 1 according to the embodiment, the optical unit 3 uses the lens integrator optical system, which includes the lens arrays 321 and 322, as the illumination optical device 32 which uniformizes illumination of the light flux emitted from the light source device 31. However, the invention is not limited thereto, and it is possible to use a rod integrator optical system which includes a light guiding rod.

In the optical unit 3 of the projector 1 according to the embodiment, a discharge type lamp, such as an ultra-high pressure mercury lamp is used as the light source lamp 311 of the light source device 31. However, various solid light emitting elements, such as a laser diode, a Light Emitting Diode (LED), an Electro Luminescence (EL) element, and a silicon light emitting element, may be used.

### REFERENCE SIGNS LIST

1 projector
3 optical unit
5 optical projection device
6 first optical system
7 second optical system
31 light source device
50 optical projection unit
51 optical projection housing
51A housing main body
51B cover
53 light transmission plate
61 first lens frame
62 second lens frame
63 third lens frame
64 fourth lens frame
61P, 62P, 63P cam pin
65 guide barrel
66 cam barrel
67 first adjusting barrel
68 second adjusting barrel
69 adjusting ring
70 adjusting and fixing member
71 reflecting mirror
351 liquid crystal panel (optical modulator)
641 first division frame (the other lens frame)
642 second division frame (one lens frame)
643 adjusting hole
644 fixing hole portion
645 fixing groove portion
646 adjustment portion
647 fixing portion
648 diaphragm
663, 664, 665 cam groove
6413 adjusting barrel
6422 adjusting maintenance barrel
6521 straight groove
C optical axis
D radius
L1 first lens group
L2 second lens group
L3 fourth lens group
L4 fourth lens group
L42 eighth lens (lens which is adjacent to diaphragm)

1. An optical projection device which projects incident image light comprising:
a plurality of lens groups; and
a plurality of lens frames that accommodate the lens groups,
wherein the optical projection device projects incident image light, has a lens frame which is divided between the diaphragm and a lens which is adjacent to the diaphragm, and
wherein one of lens frames, which are acquired through the division, includes an adjustment portion, which maintains a position of an optical axis to be adjusted, with respect to the other of lens frames which are acquired through the division.

2. An optical projection device which projects incident image light comprising:
a plurality of lens groups; and
a plurality of lens frames that accommodate the lens groups,
wherein a lens group, which is fixed, in the plurality of lens groups, has a lens frame which is divided at a specified position, and
wherein one of lens frames, which are acquired through the division, includes an adjustment portion, which maintains a position of an optical axis to be adjusted, with respect to the other of lens frames which are acquired through the division.

3. An optical projection device which projects incident image light comprising:
a plurality of lens groups; and
a plurality of lens frames that accommodate the lens groups,
wherein a lens group, which is disposed in a most incident side of the light, in the plurality of lens groups, has a lens frame which is divided at a specified position, and
wherein one of lens frames, which are acquired through the division, includes an adjustment portion, which maintains a position of an optical axis to be adjusted, with respect to the other of lens frames which are acquired through the division.

4. The optical projection device according to claim 1,
wherein the adjustment portion includes a plurality of adjusting hole portions and/or adjusting notch portions on an outer circumferential surface of the one lens frame in a radial direction around the optical axis, and
wherein the other lens frame is installed on an inner circumferential side of the one lens frame with a gap in the radial direction, and has an exposed outer circumferential surface which faces the adjusting hole portions and/or the adjusting notch portions.

5. The optical projection device according to claim 4,
wherein the plurality of adjusting hole portions and/or the adjusting notch portions are formed in positions facing each other across the optical axis.

6. The optical projection device according to claim 1, further comprising:
a fixing portion that fixes the other lens frame to the one lens frame,
wherein the fixing portion includes the plurality of fixing hole portions and/or the fixing notch portions, which expose the outer circumferential surface of the other lens frame, on the outer circumferential surface of the one lens frame in the radial direction around the optical axis.

7. The optical projection device according to claim 6,
wherein the plurality of the fixing hole portions and/or the fixing notch portions are formed at approximately regular intervals.

8. The optical projection device according to claim 6,
wherein the other lens frame includes groove portions which face the fixing hole portions and/or the fixing notch portions.

9. The optical projection device according to claim 1, further comprising:
a reflecting mirror that reflects light emitted from the lens group.

10. The optical projection device according to claim 1,
wherein the plurality of lens groups are formed to adjust focus.

11. A projector comprising:
the optical projection device according to claim 1;
a light source device that emits light; and
an optical modulator that modulates the light according to image information.
